(19) United States
(12) Patent Application Publication
(10) Pub. No.: US 2009/0310777 A1
(43) Pub. Date: Dec. 17, 2009

(54) Trust Anchor Key Cryptogram and Cryptoperiod Management Method

(75) Inventor: Thierry Moreau, Montreal (CA)

Correspondence Address: Thierry Moreau, 9130 Place de Montgolfier, Montreal, QC, H2M 2A1, CA

(73) Assignee: TRUST ANCHOR KEY CRYPTOGRAM AND CRYPTOPERIOD MANAGEMENT METHOD

(21) Appl. No.: 11/922,285

(22) PCT Filed: Jun. 22, 2006
(86) PCT No.: PCT/CA2006/001066

§ 371 Date: Dec. 14, 2007

(30) Foreign Application Priority Data
Jun. 30, 2005 (CA) 2,511,366

(51) Int. Cl. H04L 9/30; H04L 9/14; H04L 29/06

(52) U.S. Cl. 380/44; 380/277; 713/155

(57) ABSTRACT

In the field of public key cryptography, e.g. a public key infrastructure, the distribution of trust anchor keys to end-user systems is difficult when the time comes to change the public key, either because a compromise of the private key counterpart is suspected, or as a cryptoperiod policy enforcement. With the present invention, the central organization (from which the trust anchor key originates) is given the opportunity to distribute at once a number of trust anchor keys, in advance of their respective intended period of use, and without exposing the individual public keys to brute force attacks before their actual period of use. At a later time, the central organization distributes unlocking information that enables the use of a public key distributed according to the present invention. The preferred embodiment makes use of an hidden selection of a cryptographic function among a function family.

### FIELD OF THE INVENTION

The present invention relates to the general field of cryptography, and is particularly concerned with a trust anchor key cryptogram and cryptoperiod management method.

### BACKGROUND OF THE INVENTION

In the field of public key cryptography, a trust anchor key is often a public signature key of a certification authority. In other cases, a trust anchor may be a public encryption key, such as in U.S. Pat. No. 6,061,791, Moreau, Thierry, Initial Secret Key Establishment Including Facilities for Verification of Identity, issued May 9, 2000 (the corresponding Canadian patent application number is 2,289,452). In either case, a trust anchor key needs some form of integrity protection on the user system. However, no other key is available for cryptography-based integrity protection. Trust anchor keys are widely distributed, e.g. as a default configuration element in an Internet browser software.

A central organization controls the private counterpart of a trust anchor key. If everything goes well, the private key remains undisclosed to any other party. However, conservative key management guidelines include the recommendation to change a trust anchor key, like any other key, before the expiry of its cryptoperiod, as may be decided the central organization or an overseeing body (e.g. a financial sector regulatory body). The integrity protection and the key change requirements are somehow contradictory, since each key management operation, such as a key change, can be the target of fraud schemes, e.g. an impersonation attack. A related procedure is disclosed in U.S. Pat. No. 5,680,458, Spelman, Jeffrey F., Thomlinson, Mattew W., Root Key Compromise Recovery, issued on Oct. 21, 1997.

The rationales for trust anchor key change extend beyond the mere possibility of security incidents impacting the private counterpart secrecy. As soon as a public key is publicly available, powerful adversaries may start computing the mathematical solution of the underlying “hard problem” with the trust anchor key as the input (e.g. integer factorization or discrete logarithm). Such “brute force” attacks may take from days to years or even centuries to complete, depending on key sizes and the computing power available to the adversaries. Unexpected advances in specialized mathematical algorithms might also lower the cryptoperiod guidelines, creating implicit “mathematical breakthrough vulnerability.” So, it is unwise to distribute a trust anchor key replacement significantly before its actual usage period.

Against this background, there exists a need in the industry to provide a new and improved trust anchor key cryptogram and cryptoperiod management method.

An object of the present invention is therefore to provide an improved trust anchor key cryptogram and cryptoperiod management method.

### SUMMARY OF THE INVENTION

A trust anchor key is a public key selected by a central organization which keeps the private counterpart secret and uses it for digital signature purposes or public key decryption purposes. A trust anchor key is distributed to a potentially large user base. For a potential user, the trust anchor key is a configuration element in a digital system. According to the present invention, the central organization prepares at once a number of public key pairs to be used as trust anchor keys in different periods. In addition, the central organization selects independent hiding parameters for each of the public keys to which the deferred usage strategy applies. Using the hiding parameters, the central organization prepares a hiding cryptogram for each such public key, and distributes at once the collection of hiding cryptograms. The central organization safely puts aside, in a dead storage arrangement, the hiding parameters, the corresponding public key and the private key counterpart, until the time comes for the public key usage as a trust anchor key.

In the end-user systems, the trust relationship with the central organization starts with the receipt of the first trust anchor key and/or the collection of hiding cryptograms. The available integrity mechanisms should be applied as is the case with the prior art trust anchor key distribution. With the present invention, however, a later change of trust anchor key triggered by the central organization does not require any additional non-automated integrity mechanisms. The end-user system merely processes the receipt of unlocking information from the central organization as explained hereafter and may accept a new trust anchor key as a result.

When the central organization wishes to change the trust anchor key, it retrieves the relevant information from its dead storage location and broadcasts a corresponding unlocking information message to its user base. In the meantime, the new trust anchor key has been isolated from brute force attack threats, which is a foremost rationale for cryptoperiods in the first place.

The computations required by the present invention are typically performed with general purpose computer systems, and more generally by any type of systems based on stored program processors such as embedded processors or DSPs (digital signal processors), or even FPGA (field programmable gate array). Such systems use digital memory for storing their configuration. The preferred embodiment use “dead storage” in preference to a digital memory within a processing system to avoid the possible leakage of secret data during the system operation. Such dead storage can be any type of digital storage media which can conveniently hold the information relevant to a particular trust anchor key and the corresponding unlocking information. An example is a sequence of bar codes printed on ordinary office paper. The data transmission between the central organization systems and the end-user systems can use conventional data communications networks (such as the public Internet). Many types of protocol configurations can be used, as long as a released unlocking information message can be carried from the central organization to an end-user system.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

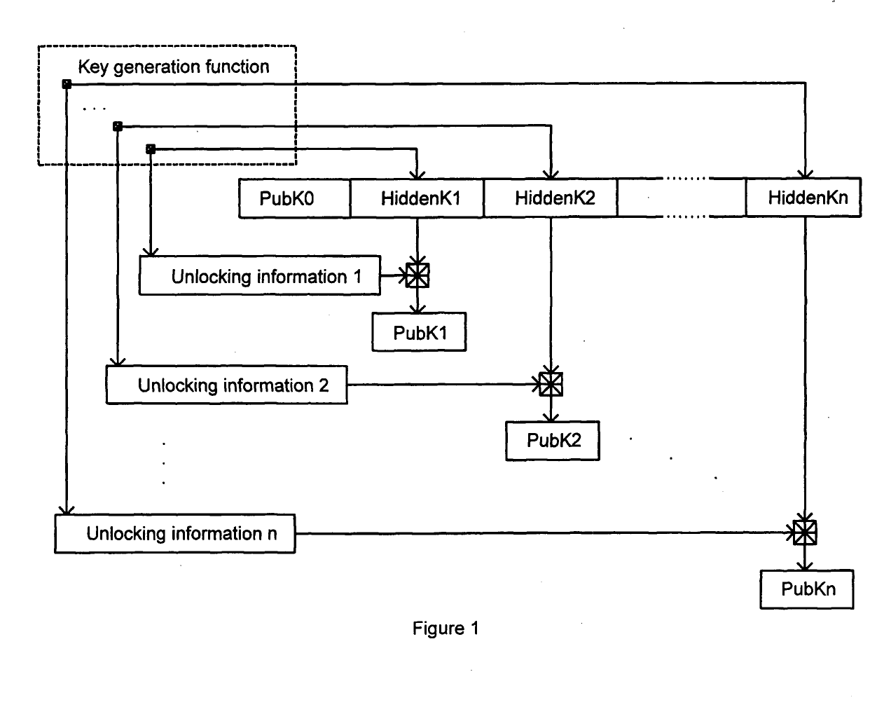

In the appended drawings, the only FIGURE 1 depicts in a schematic way some information dependencies in the present invention.

### DETAILED DESCRIPTION

A trust anchor key intended for immediate usage is distributed as PubK0. The present invention affixes hidden public keys HiddenK1, HiddenK2, up to HiddenKn to this PubK0. The data format representation is an issue that should be easy to address by someone knowledgeable of the field. The complete concatenated string is distributed once as trust anchor information to potential users. If a self-signed certificate is distributed with PubK0 as an integrity mechanism in an existing trust anchor distribution scheme, it is possible to include the complete concatenated string in the signed data in place of just PubK0.

The hidden public key HiddenKi, for 0<i≦n, is intended for usage in cryptoperiod i, but is totally meaningless until additional unlocking information is distributed to the user. The central organization that controls the private counterpart of PubK0 also establishes the public key PubKi hidden in HiddenKi, for 0<i≦n. Shortly before the start of cryptoperiod i, or any time when the central organization wishes that users rely on the trust anchor key PubKi, the required unlocking information is sent to the user, and the user software recovers PubKi from HiddenKi with cryptography-based integrity checks, i.e. the new trust anchor key is relied upon only if the integrity checks are conclusive.

For the invention to provide effective security, e.g. against brute force attacks, neither PubKi nor its private counterpart should be available until their effective use, even to insiders in the central organization. Thus, once the PubKi is hidden in HiddenKi upon initial key pairs generation, the PubKi should be put in the same dead storage as its private counterpart (e.g. using the split component technique and two different safe boxes). Since the various PubKi's (with their respective private key counterpart) will be brought into use at a different times, it is wise to put each of them in independent tamper-evident packaging for secrecy and integrity protection during their the dead storage period. The incentive to follow these rules by a central organization is the avoidance of the major embarrassment and operational disturbances created by a compromised trust anchor key that is widely distributed and tied to the organization's services and image. The present invention provides long-term security for trust anchor key, and avoids repeated key change procedures that rest on non-cryptographic integrity mechanisms.

The present invention works in part with the resistance of the hiding algorithm to brute force attacks. The desired properties for the hiding algorithm are:

1) the hiding operation takes a cleartext message as input and outputs the hiding cryptogram and the unlocking information,

2) when given only the hiding cryptogram, an adversary should not be given the opportunity to mount a brute force attack to recover the cleartext message,

3) when given both the hiding cryptogram and the unlocking information, any party can efficiently perform a validation operation, i.e. recover some alleged cleartext message and gather assurance that the hiding cryptogram may not have been produced without knowledge of the exact same cleartext message, and

4) when given only the hiding cryptogram, an adversary should not be able to produce any substitute unlocking information that would be verified by the validation operation, even with computing power resources commensurate with brute force attack on state-of-the-art cryptographic primitives.

Notes:

a) These properties allow the cleartext message to be part of the unlocking information.

b) It can be assumed that the hiding operation is performed with a secret random source meeting some entropy requirements.

c) In the property 2) above, the cleartext message may embed easy to recognize redundancy. In other words, given a publicly known hiding operation algorithm, a ciphertext-only attack is a reasonable brute force strategy for an adversary.

d) The property 4) above rules out schemes where the hiding cryptogram is a mere secure hash value of the cleartext and the unlocking information is the cleartext message.

Generally speaking, the above security properties suggest larger key spaces, larger block sizes, and larger cryptographic integrity field sizes, in reference to usual cryptographic algorithms for which parameter size choices are driven by a careful balance between efficiency and computing capacity available to adversaries who might consider brute force attacks. The cryptographic community doesn't have handy symmetric key algorithms with large parameter sizes, that would have been throughly studied. The public key cryptography schemes are usually more flexible for security parameter size extensibility.

When focusing on an individual trust anchor key, a central organization applies the present invention when it generates the trust anchor key and its private counterpart, perhaps well in advance of intended key usage. At this same occasion, the central organization selects an instance within a cryptographic function family, and uses the selected function in the hiding operation. An indication of this selection is part of the unlocking information, as unlocking parameters, notation up for selected function Fᵤₚ( ). A first implementation is a cryptographic function family where the hiding operation is either

Fᵤₚ(cleartext)=HiddenK,

or

Fᵤₚ(cleartext||up)=HiddenK,

and the unlocking information contains up and cleartext.

Nowadays, many cryptographic primitives are probabilistic, which generally means that the function takes a random input parameter that makes things harder for an adversary. This suggests the hiding operation definition

Fᵤₚ(cleartext,rnd)=HiddenK,

or

Fᵤₚ(cleartext||up,rnd)=HiddenK,

and the unlocking information contains up, cleartext, and the random input rnd.

The preferred embodiment of the present invention uses the hash function family known as MASH (Modular Arithmetic Secure Hash). This is specified in international standard document ISO/IEC 10118-4:1998, Information technology—Security techniques—Hash-functions—Part 4: Hash-functions using modular arithmetic, which is included herein by reference. The unlocking parameter is the pair <N,p> comprising the MASH modulus N and the prime number p used in the MASH final reduction function. If a probabilistic cryptographic primitive is preferred, the cleartext is prefixed with some random data, rnd, before applying the MASH algorithm.

The central organization thus selects a different MASH pair <N,p> for each cryptoperiod i, and uses the corresponding MASH algorithm to produce a secure hash integrity code HiddenKi for the corresponding PubKi. A self-signed certificate for PubKi may be affixed to the hash input string, just as a self-signed certificate PubK0 might have been affixed to PubK0 itself. When it is time to enable the trust anchor key for cryptoperiod i, the central organization releases the unlocking information: rnd (if any), PubKi, any self-signed certificate for PubKi, N, and p. Upon receipt of this information, the user systems may verify it against the HiddenKi originally configured with the trust anchor key PubK0. If HiddenKi is indeed the expected hash code, and if any self-signed certificate is verified, then the PubKi can become the new trust anchor key.

It is advantageous to use larger parameters <N,p> for trust anchor keys PubKi that are expected to be put into use at a later time, as the computing power is expected to increase over the years.

A simple example of a hiding operation for the present invention is an authenticated encryption cipher using a random symmetric key, the latter being the unlocking information and the ciphertext being the hiding cryptogram.

In summary, the present invention is organized as three interoperable processes, respectively for initial configuration by the central organization, trust anchor public key enablement by the central organization, and trust anchor key validation by the end-user systems.

The first process, initial configuration by the central organization, encompasses the steps of
generating a number of public-private key pairs,
for each one, applying a hiding operation on the public key counterpart of respective public-private key pair, and perhaps other inputs, producing a hiding cryptogram and unlocking information,
storing the array of unlocking information and the private key counterparts of the respective private-public key pairs in this array, and
releasing an array made of the hiding cryptograms.

The second process, trust anchor public key enablement by the central organization, encompasses the steps of
inputting unlocking information originated from the first process,
releasing such unlocking information,
inputting the private counterpart of the public-private key pair corresponding to the unlocking information, and
enabling the use of said private counterpart, e.g. for later digital signature generation, public key decryption, or symmetric key establishment (according to the field of application of the trust anchor key).

The third process, trust anchor key validation by an end-user system, encompasses the steps of
inputting an array of hiding cryptograms,
receiving unlocking information,
validating the received unlocking information and one of the hiding cryptograms in the array, where this validation operation recovers the public key counterpart of a public-private key pair when successful, and
if the validation was successful, enabling the use of this public key counterpart, e.g. for later digital signature verification, public key encryption, or symmetric key establishment (according to the field of application of the trust anchor key).

Although the present invention has been described with reference to a particular preferred embodiment, someone knowledgeable of the field will appreciate that various modifications and enhancements may be made without departing from the spirit and scope of the invention disclosed herein.

What is claimed is:

1. A method of trust anchor public key initial configuration comprising steps of
a) generating a plurality of public-private key pairs,
b) for each said public-private key pair, applying a hiding operation on at least the public key counterpart of respective public-private key pair, producing a hiding cryptogram and unlocking information,
c) storing the plurality of said unlocking information,
d) storing the private key counterparts of the respective private-public key pairs in said plurality of unlocking information, and
e) releasing a plurality of said hiding cryptograms.

2. The method of trust anchor public key initial configuration as in claim 1,
where said hiding operation comprises the steps of selecting a cryptographic primitive instance among a cryptographic function family and applying said cryptographic primitive instance to at least the public key counterpart of the respective public-private key pair, and
where the unlocking information comprises at least the respective selection of a cryptographic primitive instance and the public counterpart of the respective public-private key pair.

3. The method of trust anchor public key initial configuration as in claim 2
where the cryptographic function family is the Modular Arithmetic Secure Hash,
where said selection is made by selecting the MASH parameters modulus N and prime p, and
where said hiding cryptogram is the MASH primitive output with said MASH parameters modulus N and prime p.

4. The method of trust anchor public key initial configuration as in claim 1
where said hiding operation is applied to at least locally generated random data and the public key counterpart of respective public-private key pair, and
where said unlocking information comprises said locally generated random data.

5. The method of trust anchor public key initial configuration as in claim 1 where said storing steps further include preparing a plurality of digital storage media using split component technique.

6. The method of trust anchor public key initial configuration as in claim 2 where said storing steps further include preparing a plurality of digital storage media using split component technique.

7. A method of trust anchor public key enablement comprising steps of
a) inputting unlocking information originated from a hiding operation applied on at least the public key counterpart of a public-private key pair, whereas the hiding cryptogram produced by said hiding operation has been released,
b) releasing said unlocking information,
c) inputting the private counterpart of said public-private key pair, and
d) enabling the use of said private counterpart.

8. The method of trust anchor public key enablement as in claim 7,
where said hiding operation comprises the steps of selecting a cryptographic primitive instance among a cryptographic function family and applying said cryptographic primitive instance to at least said public key counterpart, and
where said unlocking information comprises at least said selection of a cryptographic primitive instance and said public counterpart, and
where said hiding cryptogram is the MASH primitive output with those parameters.

9. The method of trust anchor public key enablement as in claim 8,
where the cryptographic function family is the Modular Arithmetic Secure Hash, and
where said selection is made by selecting the MASH parameters modulus N and prime p.

10. The method of trust anchor public key enablement as in claim 7
where said unlocking information comprises an arbitrary data field, and
where said unlocking information originated from a hiding operation applied to at least said arbitrary data field and the public key counterpart of respective public-private key pair.

11. A method of trust anchor public key validation comprising steps of
a) inputting a plurality of hiding cryptograms,
b) receiving unlocking information,
c) validating said unlocking information and a hiding cryptogram among said plurality of hiding cryptograms, where said validation recovers the public key counterpart of a public-private key pair at least if said unlocking information and said hiding cryptogram is validated, and
d) enabling the use of said public key counterpart if said unlocking information and said hiding cryptogram has been validated.

12. The method of trust anchor public key validation as in claim 11,
where said unlocking information comprises at least a selection of a cryptographic primitive instance among a cryptographic function family and said public counterpart of a public-private key pair,
where said validating step verifies the equality of said hiding cryptogram with the result of applying said cryptographic primitive instance to at least said public key counterpart part of the unlocking information, and
where said public key recovered by said validating step is said public key counterpart part of the unlocking information.

13. The method of trust anchor public key validation as in claim 12,
where the cryptographic function family is the Modular Arithmetic Secure Hash,
where said selection comprises the MASH parameters modulus N and prime p, and
where said hiding cryptogram is the MASH primitive output with those parameters.
